(19) United States
(12) Patent Application Publication
(10) Pub. No.: US 2005/0105505 A1
(43) Pub. Date: May 19, 2005

(54) Transceiver for a wireless local area network having a sparse preamble data sequence

(76) Inventors: Eran Fishler, Jersey City, NJ (US); Yossi Erlich, Hod Hasharon (IL); Yaron Rashi, Ra'anana (IL)

Correspondence Address: Harold C. Moore;Maginot, Moore & Beck, Bank One Center/Tower, 111 Monument Circle, Suite 3000, Indianapolis, IN, 46204-5115, US

(21) Appl. No.: 10/704,371

(22) Filed: Nov. 7, 2003

(51) Int. Cl. H04B 1/38; H04Q 7/24; H04J 3/24

(52) U.S. Cl. 370/349; 370/338

(57) ABSTRACT

A preamble generator for a transceiver of a wireless local area network (WLAN) includes a first preamble data memory. The transceiver of the WLAN is configured to transmit data transmission burst signals, each including a preamble data sequence signal and a data section signal. The preamble data sequence signal is associated with the data transmission channel of said wireless local area network (WLAN). The first preamble data memory stores a first set of preamble data sequences for a number of different data transmission channels, wherein each preamble data sequence has a predetermined number of preamble data samples including a number of preamble data samples having large values. The peak to average ratio of the preamble data sequence signal corresponds to the peak to average ratio of the data section signal.

### FIELD OF INVENTION

The present invention relates generally to a transceiver for a wireless local area network (WLAN) which is operated simultaneously with other wireless local area networks (WLANs) in the same local area and in particular to a preamble generator and to a preamble detector of said transceiver including sparse preamble data sequences.

### BACKGROUND

FIG. 1 shows the transmission of data in a wireless system according to the state of the art. Several transceivers belonging to the same wireless local area network (WLAN) use the same data transmission channel by means of time sharing. At any specific time only one transceiver is transmitting. Accordingly the transmissions from each transceiver are burst like. For helping the receiving transceiver to identify a data transmission burst and for extracting the delivered information data the transmitting transceiver sends a predefined preamble signal preceding the data portion of the data transmission burst. The transceiver that receives the data transmission burst comprises a preamble detection unit that identifies the preamble and thus identifies the data transmission burst. The transceiver uses further the preamble for estimating data transmission and channel parameters such as channel response and carrier and timing offsets that are needed for the data information extraction.

Commonly several communication networks share the same data transmission media. Specifically collocated wireless networks utilize the same frequency spectrum.

FIG. 2 shows two collocated wireless networks according to the state of the art.

Wireless local areas networks (WLAN) represent a new form of communications among personal computers or other devices that wish to deliver digital data. A wireless network is one that does not rely on cable as the communications medium. Whether twisted pair, coax, or optical fibres, hard wiring for data communication systems within a building environment is expensive and troublesome to install, maintain and to change. To avoid these disadvantages wireless networks transmit data over the air using signals that cover a broad frequency range from few MHz to a few terahertz. Depending on the frequency involved wireless networks comprise radio wireless networks, microwave wireless networks and infrared wireless networks.

Wireless networks are used mainly for connecting devices within a building or connecting portable or mobile devices to a network. Further applications are keeping mobile devices in contact with a data base and ad hoc networks for example in committee or business meetings.

Wireless local area networks (WLAN) and wireless personal area networks (WPAN) are used to convey information over relatively short ranges. A wireless personal area network (WPAN) is defined in the IEEE 802.15.3 standard.

In many situations and scenarios several wireless local area networks (WLANs) are operated simultaneously with each other in the same local area. A typical situation would be a big office wherein many office cubicles are located belonging to different divisions of the same company, e.g. search division, accounting division, marketing division. The computers of each division are connected in such a situation by means of separate wireless local area networks (WLANs). A wireless local area network (WLAN) comprising several transceivers is referred to as a Piconet.

FIG. 2 shows typical scenario where two wireless local area networks (WLANs) are operated in the same local area. In the example shown in FIG. 1 the first Piconet WLAN_{A} comprises a Piconet Coordinator (PNC) for the wireless local area network WLAN_{A} and some additional transceivers A1, A2, A3, A4. The second Piconet WLAN_{B} comprises a Piconet Coordinator (PNCB) and further transceivers B1, B2, B3, B4, B5. The transceivers including the Piconet Coordinators can either have a fixed location or can be moveable devices. The Piconet Coordinators (PNC_{A}, PNC_{B}) are coordinating transceivers which are provided for managing the data traffic within respective wireless local area network (WLAN_{A}, WLAN_{B}).

In the shown example a first transmitting transceiver A2 transmits data to a receiving transceiver A4 of the first wireless local area network WLAN_{A} on the data transmission channel of the wireless local area network WLAN_{A}. Further a transmitting transceiver B3 of the second wireless local area network WLAN_{B} transmits data to a receiving transceiver B1 of the same wireless local network WLAN_{B} on the data transmission channel of this wireless local area network. The data exchange between transceivers is performed half duplex, i.e. a transceiver can either send or receive data over a data link to another transceiver of the same wireless local area network. The data are exchanged via data packages.

Each Piconet WLANᵢ has its respective data transmission channel, i.e. the data transmission channel is used by all transceivers of the corresponding Piconet WLANᵢ.

In most cases the frequency resources available for a wireless local area network WLAN are bounded by regulations. Usually a certain frequency band is allocated for the wireless local networks. Within this frequency band each transceiver is required to radiate no more than a specified average power spectral density (PSD).

To operate several wireless local area networks simultaneously several proposals have been made.

In frequency division multiplexing (FDM) systems according to the state of the art the allocated frequency band is divided into several sub-frequency bands. In FDM-system each data transmission channel and consequently each Piconet is using a different frequency sub-band. Thus, data transmission in different Piconets (WLANs) can simultaneously be performed without interference.

The disadvantage of FDM-systems is that the available capacity for each Piconet is reduced compared to the case where any Piconet is allowed to use the entire allocated frequency band.

The channel capacity is given by the following formula:

$$cap = \int log ( 1 + \frac{PSD ( f )}{N ( f )} ) ⅆ f$$

The capacity of each Piconet is larger if it will be allowed to use the full frequency band instead of just the allocated frequency sub-band. The reduction in the capacity in FDM-systems translates directly to throughput reduction. Consequently the achievable data bit rate for any specific transmitter-receiver distance is reduced in FDM-systems.

In a CDMA-DSSS (Code Division Multiple Access-Direct Sequence Spread Spectrum) system according to the state of the art a direct sequence spread spectrum is used as a modulation scheme. In DSSS a sequence of many short data symbols is transmitted for each information symbol. In order to support several data transmission channels or Piconets different data sequences with low cross correlation between them are used for different data transmission channels.

In a CDMA-DSSS-system each channel can use the entire frequency band until the maximum possible throughput can be achieved. If some Piconets are working in the same area then the transmission of one Piconet is seen as additional noise by the other Piconets.

The disadvantage of the CDMA-DSSS-System is that there exists a so called near-far problem. When a transceiver in one Piconet is transmitting this transmission will be seen as additional noise by other Piconets. The level of the additional noise is proportional to the cross correlation between the spreading sequences and the received power level of the interferer's signal. For example if the interfering transceiver of Piconet A is close to a receiving transceiver of Piconet B, i.e. closer than a transmitting receiver of Piconet B then the added noise level that the receiving transceiver of Piconet B sees causes a significant reduction in the achievable bit rate for the receiver, so that even a complete blocking of the data transmission channel can occur.

A further proposal according to the state of the art to operate several wireless local area networks (WLANs) simultaneously is to use a CDMA-FH(Code Division Multiple Access-Frequency Hopping)-System. In this CDMA-FH-System the original frequency band is divided into several sub-frequency bands. Any transmitting transceiver uses a certain frequency sub-frequency band for a certain time interval and moves then to the next frequency band. A predefined frequency hopping sequence controls the order of sub-frequency bands such that both the transmitting and receiving transceiver has the information when to switch to the next frequency and to what sub-frequency band.

In a conventional CDMA-FH-System the different data transmission channels are assigned with different frequency hopping sequences.

FIG. 3 shows a CDMA-FH-System according to the state of the art with four data transmission channels. A CDMA-FH-System with four data transmission channels can operate four Piconets or wireless local area networks (WLANs) simultaneously at the same local area. In the shown example any transceiver uses a certain frequency band for a transmission interval for 300 ns, remains idle for a predetermined guard time of 300 ns and uses the next frequency band within the next transmission interval etc.

The frequency hopping sequence is fixed for any data transmission channel A, B, C, D. In the given example data transmission channel A has the frequency hopping sequence abc, channel B has the frequency hopping sequence acb, channel C has the frequency hopping sequence aabbcc and channel D has the frequency hopping sequence aaccbb.

As can be seen from FIG. 3 for any two data transmission channels there are less than four (either two or three) collisions for six subsequent transmission intervals. This is also true for any arbitrary time shift of any transmitter.

A collision is a situation when two transceivers use the same frequency band at the same time. For example a collision between data transmission channel A and data transmission channel B occurs during the first transmission interval when both channels A, B use frequency fa and during the fourth transmission interval when both channels A, B use again frequency fa. A further collision is for example between channel B and channel D during the first transmission interval when both channels B, D use frequency a and the sixth transmission interval when both channels B, D use frequency fb.

When the frequency hopping order of two wireless networks differs two transceivers that belong to different wireless local area networks can transmit at the same time. It may happen that both transceivers use the same carrier frequency at the same time. Yet, collisions in all carrier frequencies never happen. The data information is coded such that occasional collisions e.g. in one carrier frequency do not cause information loss. For this purpose some redundant data is used.

FIG. 4 illustrates simultaneous data transmission from transceivers in two different networks WLAN A, WLAN B at the same time. Each data transmission burst comprises a preamble signal and a data signal. The data signal includes header data and payload data.

The preamble detector in a transceiver that intends to decode bursts in network A needs to discriminate preambles for network B. Further the receiving transceiver is able to detect and estimate relevant parameters from a legitimate preamble in the potential simultaneous presence of a non-legitimate preambles.

FIG. 5 shows the transmission of a preamble and a data section according to the state of the art in more details. As can be seen from FIG. 5 the preamble is composed of several transmission intervals which are transmitted by means of three different carrier frequencies fₐ, f_{b}, f_{c}. The preamble sequence is unique for each wireless network which is operated simultaneously with other wireless networks. The preamble sequence is transmitted during transmission intervals which have a predetermined length Tᵢₙₜₑᵣᵥₐₗ. Between the transmission intervals a guard time has to be observed.

With each transmission interval following signal s(t) is transmitted:

$$s ( t ) = sin ( 2 π {f}_{x} t ) \cdot {\sum }_{n} {c}_{n}^{i} \cdot p ( t - {nT}_{s} )$$

P(t) is a shaping pulse of duration T_{S} (1/T_{S} is proportional to the bandwidth of the signal in each band).
cₙⁱ is the n^{th} term in a predefined sequence that is used in network i. cₙⁱ gets values of ±1.
fₓ is the carrier frequency, which has the values {fₐ, f_{b}, f_{c}}.

The preamble signal according to the state of the art has a peak to average ratio (PAR) up to 12 dB for s(t) (the RF domain), based on about 0 dB for the {cₙⁱ}-digital domain. The peak to average ratio refers to the root mean square (RMS) level. The conventional preamble signal is much longer than 1/BW, wherein BW denotes the bandwidth of the frequency spectrum occupied by the transmission signal.

The peak to average ratio PAR_{P} for conventional preamble data signal as shown in FIG. 5 is close to 1 (0 dB). Common preamble signaling use binary signals (±1). Other common preamble signaling use quadrature-complex-signals. These common preamble data sequence signals are characterized by small peak to average ratios (0 dB in the digital domain).

The peak to average ratio PAR_{D} of the analogue data section signal is higher than the peak to average ratio PAR_{P} of the preamble in data transmission burst signals transmitted by transceivers according to the state of the art. In particular multi tone based modulation techniques such as OFDM have a large peak to average ratio PAR_{D} of e.g. 10 to 18 dB in the RF domain.

In noisy conditions long preamble data sequence signals are required. This is specifically true for ultra-wide-band (UWB) applications (IEEE 802.15.3a) where the transceivers are required to operate under noisy conditions. The complexity of the correlator within the preamble detector of the receiving transceiver becomes large even when the preamble detector is additions-based.

### SUMMARY

Accordingly it is the object of the present invention to provide a transceiver for a wireless local area network having an improved performance in noisy environment and in the presence of non-legitimate preambles of other wireless local area networks.

This object is achieved by a transceiver having the following features:
Transceiver for a wireless local area network (WLAN) which is operable simultaneously with other wireless local area networks (WLANs) using different data transmission channels,
wherein the transceiver transmits analogue data transmission burst signals including an analogue preamble data sequence signal which is specific for the data transmission channel of the wireless local area network (WLAN) of said transceiver and an analogue data section signal,
wherein the transceiver comprises:
(a) a preamble data generator having:
(a1) a first preamble data memory for storing a first set of sparse preamble data sequences for the different data transmission channels,
wherein each sparse preamble data sequence has a predetermined number (N) of preamble data samples,
wherein the number (M) of preamble data samples within the sparse preamble data sequence having a value is such that the peak to average ratio PAR_{P} of the analogue preamble data sequence signal corresponds to the peak to average ratio PAR_{D} of the analogue data section signal,
(a2) a first preamble selector for selecting a sparse preamble data sequence from the first set of preamble data sequences stored in said first preamble data memory in response to a first selection control signal;
(b) a preamble detector having:
(b1) a second preamble data memory for storing a second set of sparse preamble data sequences for the different data transmission channels,
wherein each sparse preamble data sequence has a predetermined number (N) of preamble data samples,
wherein the number (M) of preamble data samples within the sparse preamble data sequence having a non zero value,
(b2) a second preamble selector for selecting a sparse preamble data sequence from the second set of preamble data sequences stored in said second preamble data memory in response to a second selection control signal,
(b3) a correlation unit which correlates a digitized time domain reception signal received by said transceiver with the sparse preamble data sequence selected by the second preamble selection to generate a correlation output signal;
(c) a control unit for generating the first selection control signal and the second selection control signal.

The advantage of the transceiver according to the present invention is that the probability of a false alarm, i.e. the identification of noise or a non-legitimate preamble as a legitimate preamble is low.

A further advantage is that the probability of a miss-detect i.e. the failure of the transceiver to detect a legitimate preamble is low.

With the transceiver according to the present invention the timing estimation, i.e. time shift estimation, in a noisy environment, in distorting environment and in the presence of non-legitimate preambles is improved.

A further advantage of the transceiver according to the present invention is that the complexity for the preamble detector is low.

The preamble generator employed in the transceiver according to the present invention generates preamble data sequences to generate a preamble data sequence signal having a larger peak to average ratio PAR_{P} compared to conventional preamble data sequences but without exceeding a peak to average ratio PAR_{D} of the data section signal. The number (M) of preamble data samples having large values within a predetermined number (N) of preamble data samples of the preamble data sequence is low, i.e. the density of preamble data samples having a non zero value is low. Accordingly the preamble data sequences employed by the transceiver according to the present invention are sparse preamble data sequences having a low density of preamble data samples with large values.

The energy of transmitted preamble data samples is at least twice the energy of the maximum of the remaining preample data samples with small values.

The auto-correlation of each preamble data sequence stored in a first memory of the preamble generator within the transceiver has a narrow main auto-correlation lobe in the time domain.

Further the auto-correlation of each preamble data sequence has small side lobes in the time domain.

The cross-correlation between the preamble sequences within a set of preamble sequences has a small maximal absolute value.

These features enable performance improvement of the transceiver according to the present invention because higher preamble detection rates can be achieved.

Further these features lower the probability of false detection under the constrains of a fixed preamble sequence length (N) compared to conventional transceivers employing preamble sequences according to the state of the art.

In a preferred embodiment the transceiver according to the present invention comprises a scheduler which schedules the selected sparse preamble data sequence output by the preamble generator before a digital time domain data signal to form a digital transmission burst signal.

In a preferred embodiment of the transceiver according to the present invention the transceiver comprises at least one digital analogue converter for converting the digital transmitter burst signal to an analogue transmission burst base band signal.

In a further preferred embodiment of the transceiver according to the present invention the transceiver comprises an upconverter which converts the analogue transmission burst base band signal to an RF-transmission burst signal by modulating said transmission burst base band signal with a carrier signal having a modulation carrier frequency within a predetermined transmission frequency band.

In a preferred embodiment of the transceiver according to the present invention the RF-transmission signal is transmitted during predetermined transmission intervals.

In a preferred embodiment of the transceiver according to the present invention the transmission frequency band is changed with every new transmission interval.

In a further embodiment of the transceiver according to the present invention the RF-transmission burst signal is a multi tone based modulated signal (OFDM).

In a preferred embodiment of the transceiver according to the present invention each transmission interval has a predetermined length (Tᵢₙₜₑᵣᵥₐₗ).

In a preferred embodiment of the transceiver according to the present invention the transmission interval length (Tᵢₙₜₑᵣᵥₐₗ) is the product of the number (N) of the preamble data samples in a preamble data sequence and the duration (Tₛₐₘₚₗₑ) of a transmitted preamble data sample signal.

In a preferred embodiment of the transceiver according to the present invention the length (Tₛₐₘₚₗₑ) of a transmission preamble data sample is smaller than the inverse of the frequency bandwidth (BW) of the frequency band employed for the transmission of the data transmission burst signal (Tₛₐₘₚₗₑ≦1/BW).

In a further embodiment of the transceiver according to the present invention the preamble data sequence signal comprises high power signal sections corresponding to the large samples of the selected preamble data sequence and low power signal sections corresponding to the data samples of the selected preamble data sequence having low values.

In a further preferred embodiment of the transceiver according to the present invention the high power signal sections have an energy which is higher than a first energy level (E1) and the low power signal sections have an energy which is lower than a second energy level (E2), wherein the first energy level (E1) is at least twice higher than the second energy level (E2).

In a preferred embodiment of the transceiver according to the present invention the length (Tₛₐₘₚₗₑ) of a transmitted high power signal section is smaller than the inverse frequency bandwidth multiplied by a factor 4.

In a still further preferred embodiment of the transceiver according to the present invention the length of a transmitted low power signal section is smaller by three times than the length of the longest high power signal section.

In a still preferred embodiment of the transceiver according to the present invention the length of the low power signal sections are not constant. Each signal section may have up to three other signal sections with the same length.

The transceiver according to the present invention comprises a preamble generator and a preamble detector.

In a preferred embodiment of the preamble generator according to the present invention the preamble generator comprises the following features:
Preamble generator for a transceiver of a wireless local area network (WLAN) which is operable simultaneously with other wireless local area networks (WLANs) using different data transmission channels,
wherein the transceiver of said wireless local area network (WLAN) transmits analogue data transmission burst signals each including an analogue preamble data sequence signal which is specific for the data transmission channel of said wireless local area network (WLAN) and an analogue data section signal,
wherein the preamble generator comprises:
a first preamble data memory for storing a first set of sparse preamble data sequences for the different data transmission channels,
wherein each sparse preamble data sequence has a predetermined number (N) of preamble data samples,
wherein the number (M) of preamble data samples within the sparse preamble data sequence having large values is such that the peak to average ratio PAR_{P} of the analogue preamble data sequence signal corresponds to the peak to average ratio (PAR_{D}) of the analogue data section signal.

In a preferred embodiment of the preamble generator according to the present invention the data samples having low values are distributed within the preamble data sequence unevenly.

Accordingly the data samples having values are not equidistant to each other within the preamble data sequence.

In a preferred embodiment of the preamble generator according to the present invention the preamble generator comprises a preamble selector for selecting a sparse preamble data signal from the first set of preamble data sequences stored in said first preamble data memory in response to a first selection control signal.

In a further preferred embodiment of the preamble generator according to the present invention each sparse preamble data sequence stored in said first preamble data memory is a time domain signal comprising a predetermined number (N) of preamble data samples.

In a preferred embodiment of the preamble generator according to the present invention each preamble data sample comprises a predetermined number (n) of preamble data bits.

In a typical embodiment of the preamble generator according to the present invention each preamble data sample comprises 4 to 5 preamble data bits.

As a consequence several signal levels for the preamble data sample signal can be provided, e.g. 2⁴ or 2⁵ signal levels for n 4 or 5 respectively.

In a preferred embodiment of the preamble generator according to the present invention the first set of sparse preamble data sequences comprises a predetermined number (K) of sparse preamble data sequences. The number (K) of sparse preamble data sequences stored in the first memory corresponds to the number of employable data transmission channels which can be used by different wireless local area networks which are operated at the same time.

In a further preferred embodiment of the preamble generator according to the present invention the number (n) of preamble data bits for each preamble data sample is at least two.

In a preferred embodiment the preamble detector of the transceiver according to the present invention comprises the following features:

Preamble detector for a transceiver of a wireless local area network (WLAN) which is operable simultaneously with other a wireless local area networks (WLANs) using different data transmission channels.

In a preferred embodiment the preamble detector according to the present invention the preamble detector comprises an energy calculation unit which calculates an energy level from the correlation output signal.

In a further preferred embodiment the preamble detector according to the present invention comprises a low path filter for filtering the energy signal calculated by said energy calculating unit.

In a further preferred embodiment of the preamble detector according to the present invention the preamble detector comprises a peak detector for detecting a peak of the filtered energy signal.

In a preferred embodiment the transceiver transmits the transmission burst signal to a receiving transceiver of the same wireless local area network during data transmission intervals with changing frequency bands.

In a preferred embodiment the preamble detector according to the present invention comprises a logic for evaluating the peak detection signals of the peak detector for all frequency bands employed during the transmission of the transmission burst signal.

In a preferred embodiment the preamble detector according to the present invention comprises a parameter extraction unit for extracting transmission and channel characteristic parameters from the evaluated peak detection signals.

In a preferred embodiment the parameter extraction unit extracts the carrier offset between the modulation carrier frequency of the transmitting transceiver and the demodulation carrier frequency of the receiving transceiver.

The invention further provides a method for calculating preamble data sequence for a wireless local area network (WLAN) transceiver.

The method for calculating a preamble data sequence comprises in a preferred embodiment the following steps:
(a) calculating a number (M) of data samples having a non zero value depending on a predetermined number (N) of data samples of a preamble data sequence and a predetermined peak to average ratio PAR_{D} of an analogue data section signal wherein M=ceil[N/PAR_{D}];
(b) providing a set of binary vectors (B) wherein each binary vector (B) has (M) binary (±1) vector elements;
(c) determining a locations vector (U) composed of (M) monotonically increasing integer numbers which minimizes the absolute autocorrelation function |AutoCorr(m)|

$$and where Autokorr ( m ) = {\sum }_{K = max ( m , 0 )}^{min ( N - 1 , n - 1 + m )} {c}_{K} \cdot {c}_{K + m}$$

$$and {c}_{K} \{ \begin{matrix}1 & if k = {u}_{m} , for m ∈ \{ 1 , 2 …M \} \\ 0 & otherwise \end{matrix} \}$$
(d) selecting a set of K binary sectors (binary means±1) Bₖ=(b₁^{k}, b₂^{k} . . . b^{k}ₘ) which satisfy:

$$\vert {\sum }_{m = 1}^{M} {b}_{m}^{k} \cdot {b}_{m}^{q} \vert \leq A$$

for any pair 0≦k<K, 0≦q<K, k≠q

$$where A = {max}_{m \neq 0} \{ AutoCorr ( m ) \}$$

where K corresponds to the number of data transmission channels of the transceiver.
(e) Using preamble K data sequences, defined by the K pairs (U, Bₖ), as:

$$P ( U , B ) = ( {c}_{0} , {c}_{1} … {c}_{N - 1} )$$

In a preferred embodiment of the method according to the present invention the calculated preamble data sequence is spectrally shaped.

In a preferred embodiment of the method for calculating a preamble data sequence the peak to average ratio PAR_{P} of the analogue preamble signal for the spectrally shaped preamble data sequence is calculated.

In a preferred embodiment of the method according to the present invention the calculated peak to average ratio PAR_{P} of the analogue preamble signal is compared with the peak to average ratio PAR_{DATA} of the analogue data section signal.

In a preferred embodiment of the method according to the present invention the spectrally shaped preamble data sequence is stored as a sparse preamble sequence in a preamble data memory of the transceiver when the peak to average ratio PAR_{P} of the spectrally shaped preamble data sequence is smaller or equal to the peak to average ratio PAR_{D} of the data section signal of the data transmission burst.

In the following preferred embodiments of the transceiver for a wireless local area network and the method for calculating preamble data sequences for a wireless local area network transceiver are described with reference to the enclosed figures.

### BRIEF DESCRIPTION OF THE DRAWINGS

FIG. 1 shows the transmission of analogue data transmission burst signals by a wireless network according to the state of the art;

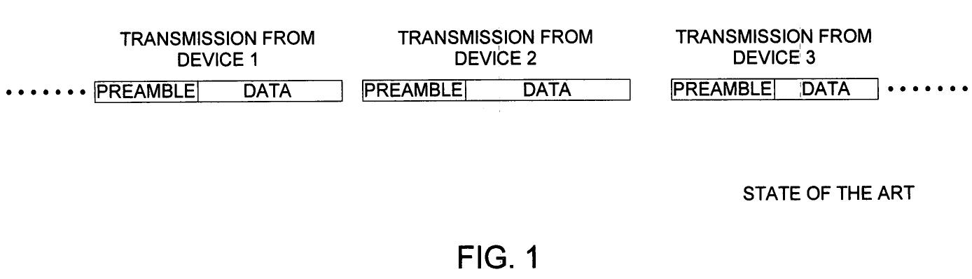

FIG. 2 shows schematically two different wireless local area networks each comprising several transceivers which are operated simultaneously according to the state of the art;

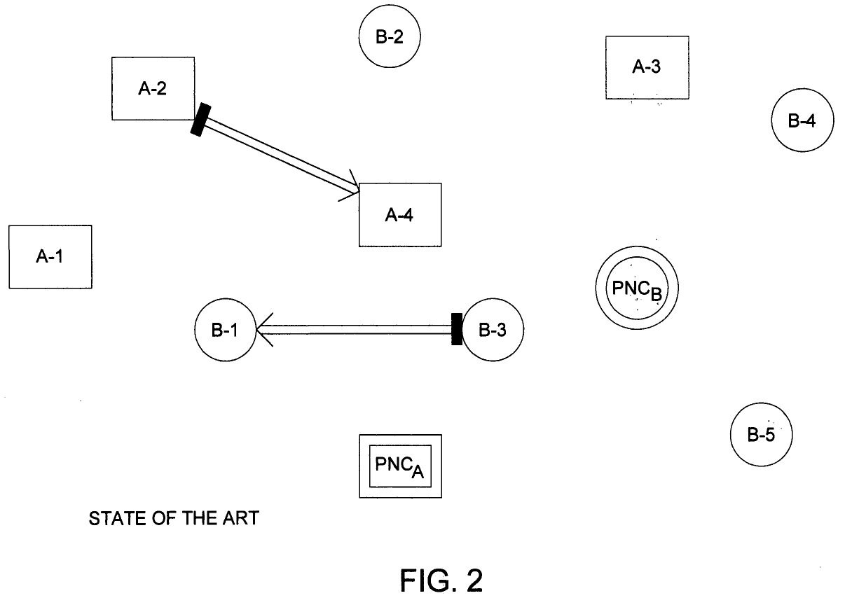

FIG. 3 shows a frequency hopping scheme employed by wireless local area networks according to the sate of the art using four different data transmission channels;

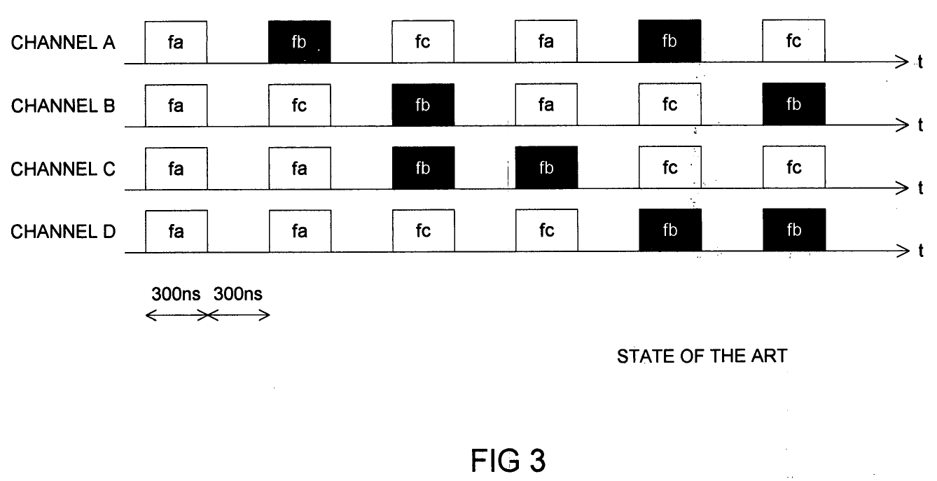

FIG. 4 shows the transmission of analogue data transmission burst signals by two wireless local area networks which are operated simultaneously by the same local area;

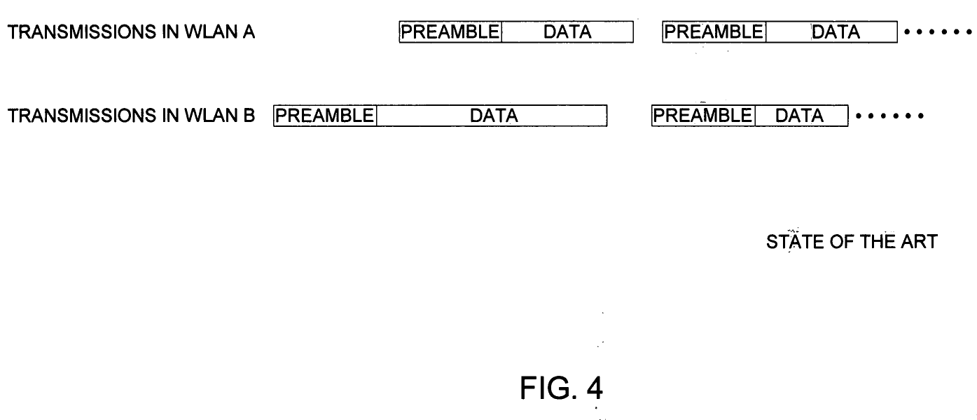

FIG. 5 shows a timing diagram of the transmission of a preamble data sequence and a data section signal within data transmission intervals according to the state of the art;

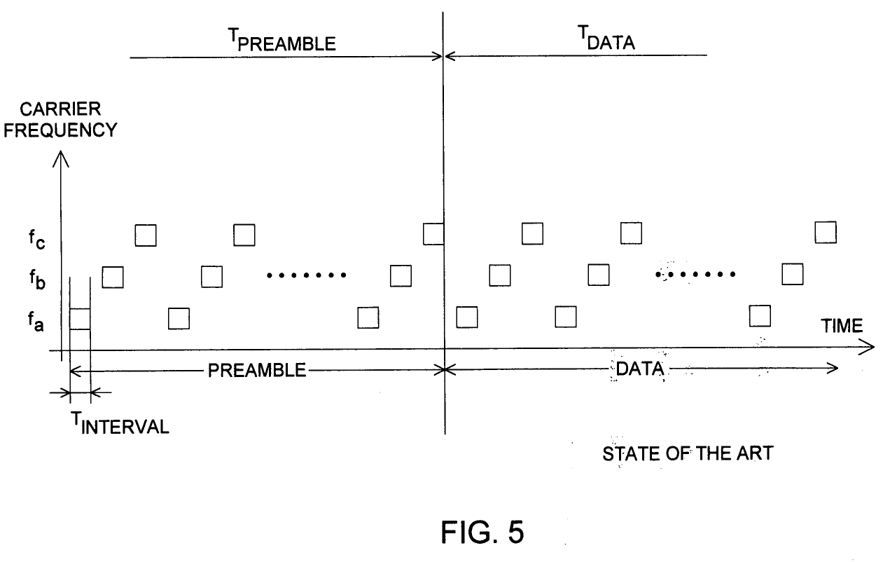

FIG. 6 shows a block diagram of a transceiver according to the present invention;

FIG. 7 shows a block diagram of a preamble generator included in the transceiver according to the present invention;

FIG. 8a shows a block diagram for a preamble detector employed by a transceiver according to the present invention;

FIG. 8b shows a flowchart for illustrating the functionality of the preamble detector according to the present invention as shown in FIG. 8a;

FIG. 9 shows a flowchart for illustrating a method for calculating the preamble data sequence for a wireless local area network transceiver according to the present invention;

FIG. 10 shows a timing diagram for illustrating an analogue preamble data sequence signal transmitted by wireless local area network transceiver according to the present invention;

FIG. 11 shows a timing diagram for illustrating the carrier offset detection performed by the wireless local area network transceiver according to the present invention;

FIG. 12 shows a diagram for illustrating the carrier offset detection performed by the wireless local area network transceiver according to the present invention.

### DETAILED DESCRIPTION

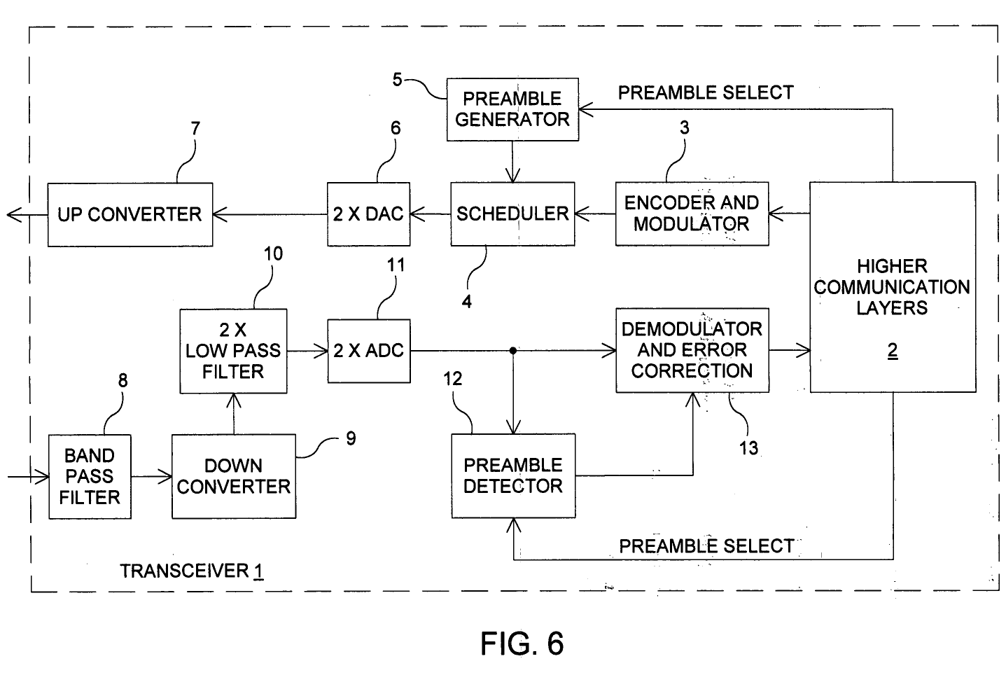

As can be seen from FIG. 6 the transceiver 1 for a wireless local area network (WLAN) according to the present invention comprises a transmitter and a receiver.

The transmitter converts data information packets from higher communication layers into RF (radio frequency) signals. The receiver of the transceiver extracts packet information from received RF signals.

As can be seen from FIG. 6 the transmitter included in the transceiver 1 according to the present invention comprises the following units. The transmitter comprises an encoder and modulating unit 3 which encodes the data bits received from a higher communication layer control unit 2 by adding redundant bits and modulates the digital data signal thus generating a time domain sampled signal. This time domain sampled signal is in a preferred embodiment is a dual signal or complex signal. The complex signal (I+iQ) is supplied by the encoding and modulating unit 3 to a scheduler 4.

The transmitter included in the transceiver 1 further comprises a preamble generator 5. The preamble generator 5 supplies a digital preamble data sequence to the scheduler 4. The preamble data sequence is specific for the data transmission channel used by the transceiver 1, i.e. the digital data sequence generated by the preamble generator 5 is unique for a wireless local area network (WLAN) which includes the transceiver 1 as shown in FIG. 6. The digital preamble data sequence supplied by the preamble generator 5 to the scheduler 4 is a time domain sampled signal and is in a preferred embodiment a real digital signal. In an alternative embodiment it is a complex digital signal.

The scheduler 4 of the transceiver 1 assembles the data sample sequence supplied by the encoding and modulating unit 3 and the digital preamble data sequence generated by the preamble generator 5 to perform a digital data transmission burst which is output to at least one digital analogue converter 6. The digital analogue converter 6 converts the digital time domain signal received from the scheduler 4 into a continues analogue signal. In a preferred embodiment two digital analogue converters are employed to convert a complex digital data transmission burst signal received from the scheduler 4. The output of the digital analogue converter 6 is connected to an up-converter 7. The up-converter 7 converts the base band analogue continues signal generated by the digital analogue converter 6 to an RF-signal by modulating the received signal with a carrier signal to generate an analogue data transmission burst signal. The generated analogue data transmission burst signal is transmitted by the transceiver 1 via an antenna to a receiving transceiver of the same wireless local area network using the same data transmission channel. In a preferred embodiment of the up-converter 7 the up-converter 7 includes two modulators having a 90 degree phase shift between the two modulators. When frequency hopping is employed the modulation carrier is periodically changed.

The transceiver 1 further comprises a receiver which includes a band path filter 8 for filtering the received RF-signal supplied from the antenna of the transceiver 1.

The output of the band path filter 8 is connected to a down-converter 9. The down-converter demodulates the filtered RF-signal and converts the RF-signal to a complex base band signal. When frequency hopping is employed the demodulation frequency used by the down-converter is periodically changed.

At the output side of the down-converter 9 an analogue low path filter 10 is provided.

At least one analogue digital converter 11 samples the continuos time signal supplied from the low path filter 10 for producing a discrete time domain signal.

The transceiver 1 further comprises a preamble detector 12 which is provided for detecting the existence of a predefined preamble which is specific for the wireless local area network (WLAN) to which the transceiver 1 belongs. Further the preamble detector 12 extracts parameters for demodulating the received data transmission burst. These parameters are supplied by the preamble detector 12 to a demodulating and error correction unit 13.

The demodulator and error corrector unit 13 demodulates the received data section of the data transmission burst using the encoded redundancy to estimate the information content of the received data packet.

As can be seen the transceiver 1 according to the present invention includes a preamble generator 5 and a preamble detector 12 which are controlled by the higher communication layer control unit 2.

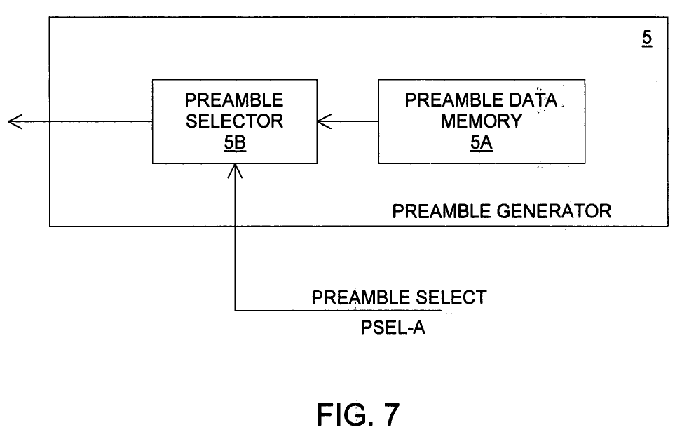

FIG. 7 shows a preferred embodiment of the preamble generator 5 as shown in FIG. 6. The preamble generator 5 according to the present invention comprises a first preamble data memory 5a for storing a first set of sparse preamble data sequences for different data transmission channels. Each preamble data sequence stored in the preamble data memory 5a comprises a predetermined number (N) of preamble data samples.

Each sparse preamble data sequence stored in the preamble data memory 5a has a predetermined number (N) of preamble data samples. The predetermined number (N) is in a preferred embodiment N=128.

The number (M) of preamble data samples within the sparse preamble data sequence having large values is such that the peak to average ratio PARₚ of the analogue preamble data sequence signal corresponds to the peak to average ratio PAR_{d} of the analogue data section signal. Multi tone based modulation techniques such as OFDM are characterized by a large peak to average ratio PAR_{d} of the analogue data section signal, e.g. 10 to 18 dB. The peak to average ratio PARₚ of the preamble data sequence signal is equal or slightly smaller than the peak to average ratio PAR_{D} of the analogue data section signal.
PAR_{P}≦PAR_{D}

The energy of transmitted data preamble data samples having large values is at least twice the energy of the maximum of the transmitted remaining preamble data samples having small values.

The peak to average ratio PAR_{P} of the preamble data sequence signal employed by the transceiver according to the present invention is higher than used by conventional transceivers but without exceeding the data sections peak to average ratio PAR_{D}.

Since the number (M) of data samples within the preamble data sequence having large values is small, the peak to average ratio PAR of the preamble section has increased. The small number (M) of preamble data samples is as a consequence that the density large data samples within a preamble data sequence is low so that a sparse preamble data sequence is used having a sparse density of large data samples.

By employing preamble data sequences having a small number of large data samples leads to an analogue preamble data sequence signal where the signal sections corresponding to the large data samples have an amplitude which is much higher than of the signal sections corresponding to the small preamble data samples. Consequently the peak to average ratio of the analogue preamble data sequence signal is increased while at the same time the number (M) of large data samples within the preamble sequence is decreased. By decreasing the number of non zero data samples within the preamble data sequence the circuit complexity to detect preamble sequences by a transceiver can be diminished.

The preamble generator 5 as shown in FIG. 7 comprises a preamble selector 5b controlled by the higher communication layer control unit 2 by means of a preamble select control signal. The preamble selector 5b selects the sparse preamble data sequence from the first set of preamble data sequences stored in the preamble data memory 5b of the preamble generator 5 in response to the first preamble selection control signal PSEL-1 from the higher communication layer control unit 2. The selected preamble data sequence is applied to a scheduler 4.

In a preferred embodiment of the preamble generator 5 as shown in FIG. 7 the preamble data memory 5a memorizes four sparse preamble data sequences thus enabling four data transmission channels for the transceiver 1 according to the present invention. Each preamble data sequence which is stored in the preamble data memory 5a comprises in a preferred embodiment 128 preamble data samples. Each preamble data sample comprises in a preferred embodiment four to five preamble data bits so that 2⁴ or 2⁵ quantization levels can be employed.

The scheduler 4 assembles the data section supplied by encoder and modulating unit 3 with the selected preamble data sequence so that the preamble data sequence precedes the data section. The scheduler 4 supplies the assembled data as a digital data transmission burst to the digital analogue converter 6.

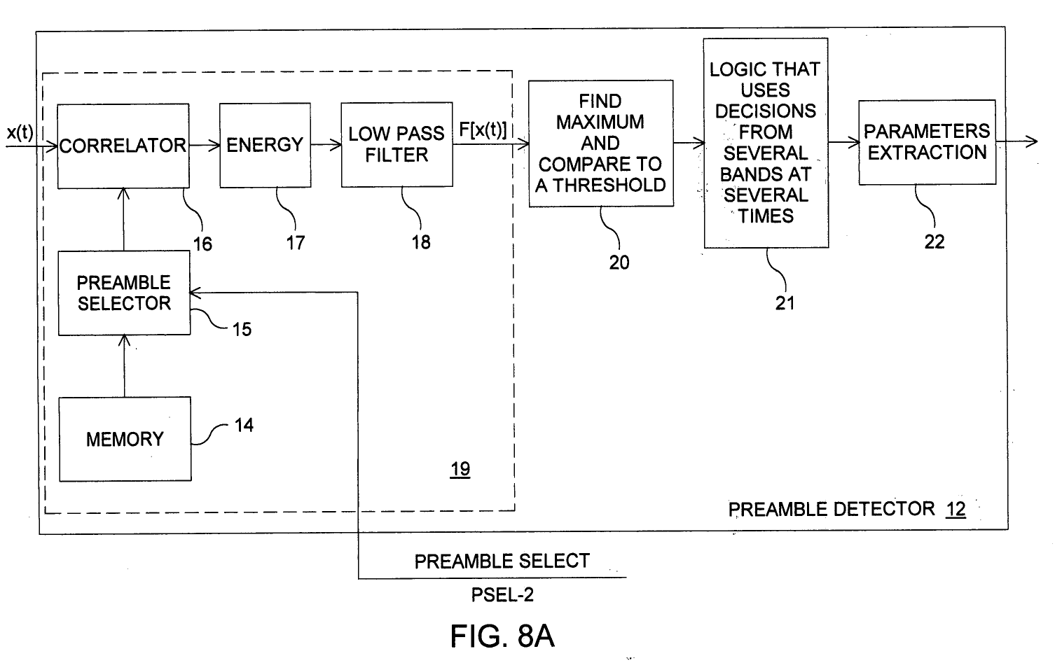

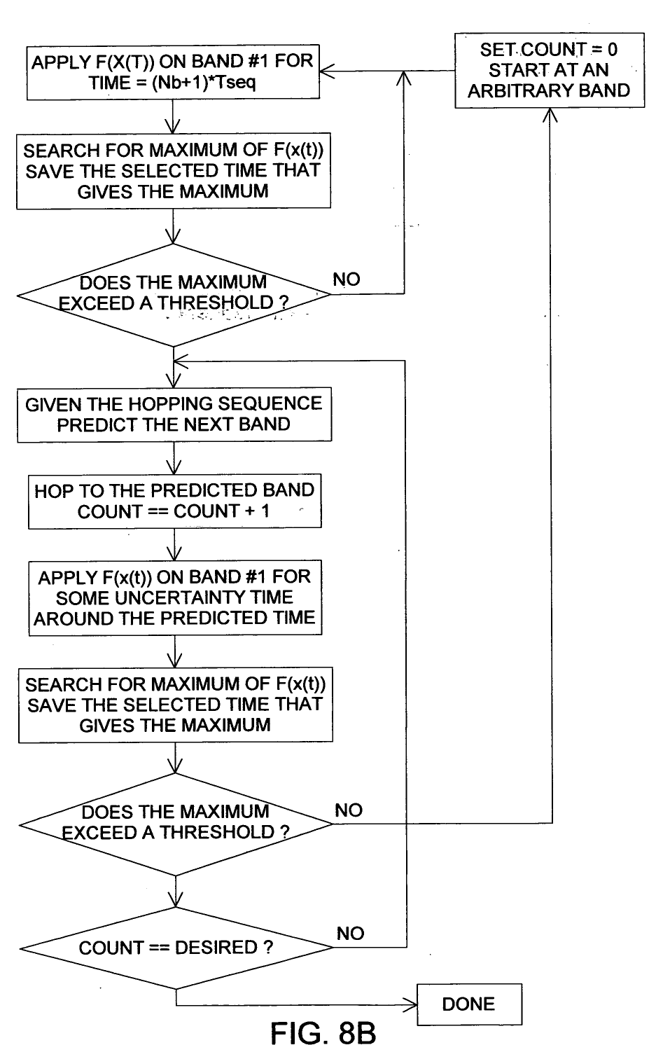

FIG. 8a shows a preferred embodiment of a preamble detector 12 within the transceiver 1 according to the present invention.

The preamble detector 12 comprises a second preamble data memory 14 for storing a second set of sparse preamble data sequences for different data transmission channels. The preamble detector 12 further includes a preamble selector 15 for selecting a sparse preamble data sequence from the second set of preamble data sequences stored in the second preamble data memory 14. The selection is performed in response to a second preamble selection signal PSEL-2. The preamble selection signal is generated by the higher communication layer control unit 2. The preamble detector 12 further comprises a correlator 16 which correlates a digitized time domain reception signal received by the transceiver 1 and converted by the analogue digital converter 11 with the sparse preamble data sequence selected by the second preamble selector 15. The correlator 16 generates a correlation output signal. The preamble data memory 14 comprises a second set of preamble sequences each having N time domain preamble data samples. In a preferred embodiment the memory 14 stores preamble data sequences having real preamble data samples. The number of preamble data sequences stored in the memory 14 corresponds to the number of wireless local area networks which are operated simultaneously in the same area. Each wireless local area network uses a different preamble data sequence for identification so that K such preamble data sequences are memorized.
{cₙ^{k}}, n=0, . . . , N−1, k=1, . . . , K.

In a preferred realization, instead of memorizing all the N samples (for each sequence), only M (M<N) non-zero values are memorized.

The preamble selector 15 selects a preamble data sequence in response to the preamble select control signal out of the K possible preamble data sequences.
{cₙ^{k}}, n=0, . . . , N−1

The correlator 16 correlates the incoming complex digital signal x(t) with the selected preamble data sequence.

$${c}_{n} = \{ \begin{matrix} {b}_{m}^{k} & if n = {u}_{m} , for m ∈ \{ 1 , 2 … M \} \\ 0 & otherwise \end{matrix} \}$$

$$CorrelatorOut = {\sum }_{n - 0}^{N - 1} CorrelatorInput ( t - n ) \cdot conjugate ( {c}_{n}^{k} )$$

The preamble detector 12 further comprises an energy calculation unit 17 which calculates an energy signal from the correlation output signal generated by the correlator 16.

The energy of the correlator output is computed by taking the sum squares of the real signal and the imaginary signal.
EnergyOut(t)=[Re(CorrelatorOut(t))]²+[Im(CorrelatorOut(t))]²
The broadband communication channel between the transceivers spreads the preamble in the time domain which can be modeled by a convolution of the transmitted signal with a channel impulse response. Accordingly the preamble detection is done by summing up the square magnitude of consecutive cross correlation outputs. The output of the energy calculation unit 17 is connected to a low path filter 18. The low path filter 18 filters the energy signal calculated by the energy calculating unit 17.

The preamble data memory 14, the preamble selector 15, the correlator 16, the energy calculating unit 17 and the low path filter 18 are integrated in a preferred embodiment into a calculation unit 19.

The preamble detector 12 as shown in FIG. 8a further comprises a peak detector 20 for detecting a peak of the filtered energy signal. The peak of a low path filter output signal is used to estimate the timing of the received signal. The peak usually occurs when the received signal is fully aligned with the correlators reference time provided that the transmission broadband communication channel is not excessively noisy.

The preamble detector 12 further comprises a logic 21 for evaluating the peak detecting signal of the peak detector 20 for all frequency bands employed during the transmission of the transmission burst signal. The logic 21 accumulates information extracted from several frequency bands at several timings when frequency hopping is employed during the transmission of transmission burst signals.

The preamble detector 12 further comprises a parameter extraction unit 22 for extracting transmission parameters from the received signal (ADC output). In a preferred embodiment the parameter extraction unit 22 extracts the carrier offset between the modulation (transmitting transceiver) and the demodulation (receiving transceiver) carrier frequencies.

In a preferred embodiment the memorized preamble sequences stored in the second preamble sequence memory 14 of the preamble detector 12 is a set of N ternary data samples {−1, 0, 1} or N 5-complex-values samples {−1, 0, 1, −i, i} even when the transmitted preamble data sequence stored in the preamble generator 5 of the transmitting transceiver is richer, i.e. has more levels since each data sample is coded with more than two bits. Storing only ternary (or 5-complex-values) data samples for the data sequences in the preamble data memory 14 has the advantage that the complexity of the correlator 16 is reduced. The number (M) of non zero preamble data samples of each preamble data sequence stored in preamble data memory 14 is significantly smaller than the number (N) of preamble data samples of each sparse preamble data sequence. Accordingly only M binary numbers are stored in the preamble data memory 14 of the detector 12 wherein the set of M binary numbers is coupled with indices.

The preamble data sequence stored in the memory 14 is such that it has good autocorrelation properties and good cross-correlation properties.

For a noiseless environment the peak value at the output of the low path filter 18 is much higher than the other off peak values. This improves the timely alignment in noisy and distorting environment. This property is referred to as a good autocorrelation property of the preamble data sequence.

The preamble sequence P=(c₀, c₁, . . . , c_{N-1}), which is stored in the first preamble memory of to the preamble generator has a corresponding matching preamble sequence in the second preamble data memory 14 of the detector 12. The matching preamble sequence Q=(d₀, d₁, . . . , d_{N-1}) is a small faction M:N of non-zero preamble data samples M out of the predetermined number N of preamble data samples, where the matching preamble sequence fulfils the following condition:

$$\frac{\vert {\sum }_{n = 0}^{N - 1} {c}_{n} \cdot Conj ( {d}_{n} ) \vert}{{( {\sum }_{n = 0}^{N - 1} {\vert {c}_{n} \vert}^{2} )}^{1 / 2} \cdot {( {\sum }_{n = 0}^{N - 1} {\vert {d}_{n} \vert}^{2} )}^{1 / 2}} \leq F$$

−20·log₁₀(F) is the tolerable loss (in dB) for using the matching preamble sequence Q for the preamble detector instead of the first preamble data sequence P memorized in the preamble generator. F=0.8 results in a loss smaller than 2 dB.

When a matching preamble is received from an other transceiver belonging to the same wireless local network the peak value at the output of the low path filter 18 is much higher compared to a situation when an alien preamble sequence from a different network is received. This property is referred to as a good cross-correlation property of this preamble data sequence.

The cross correlation of each preamble sequence stored in the preamble generator 5 with the respective sequence in the preamble detector 12 has an narrow main lobe in the time domain. Further each such cross-correlation has small side lobes in the time domain. Each cross correlation between preamble sequence stored in the preamble generator 5 and the respective sequence in the preamble detector 12 has a small maximal absolute value.

FIG. 8b shows a flowchart of the functionality of the peak detector 20 and the evaluating unit 21 within the preamble detector 12. The peak detector 20 receives from the calculating unit 19 a function (F) of the digitized time domain signal x(t). This filtered energy signal is supplied to the peak detector 20. The maximum of this signal is searched for a selected time by comparing it with a threshold. When the maximum of the supplied signal exceeds the predetermined threshold within the selected time the next frequency band is selected by the evaluating unit 21 according to the predetermined frequency hopping sequence. When the frequency band is changed a counter is incremented and the output signal of the calculating unit 19 F(x(t)) is applied for some (uncertain) time around the predicted time.

Again the maximum of the applied signal F(x(t)) is searched and the selected time which gives the maximum value is stored.

In a further step is checked whether the maximum exceeds a threshold. If not a counter is reset to zero and the procedure restarts at an arbitrary frequency band. If the maximum exceeds the threshold is checked in a further step whether the count value is reached a desired preset count value. If the preset count value has reached the procedure stops.

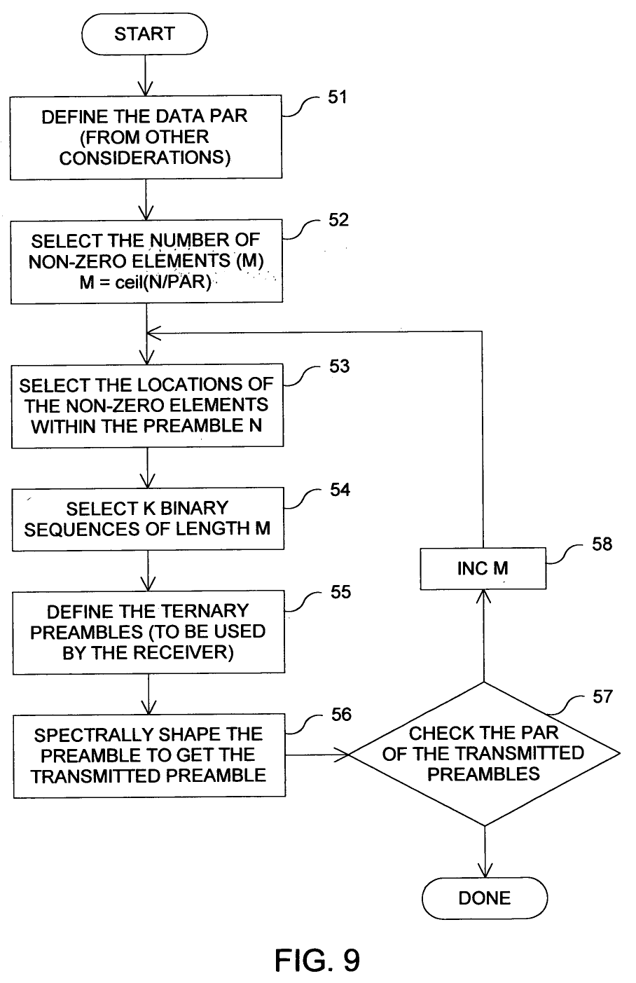

FIG. 9 shows a general flowchart of a method for calculating a preamble data sequence for a wireless local area network transceiver according to the present invention.

In a first step S1 the peak to average ratio PAR_{D} of the data section is defined. A typical value of a peak to average ratio of the data section signal is 10 dB (for the base-band signal).

In a further step S2 the number of non zero preamble data samples (M) is selected so that the number (M) of non zero preamble data samples fulfills the following equation:
M=ceil{N/PAR_{D}}

The function ceil (ceiling delivers the next high integer number e.g. for a value of 6.3 the ceiling value is 7).

In the next step S3 a locations vector (U=(u₁, u₂, . . . u_{M})) composed of M monotonically increasing integers 0=u₁<u₂<u₃< . . . u_{M}=N−1, 0<M<N is searched which satisfies some or all of the following conditions:

Minimizes |AutoCorr(m)| for the preamble p(U, B) where B=(1, 1, . . . , 1), for any non-zero m

$$\begin{matrix} Where Autokorr ( m ) = {\sum }_{K = max ( m , 0 )}^{min ( N - 1 , n - 1 + m )} {c}_{K} \cdot {c}_{K + m} \\ And {c}_{K} \{ \begin{matrix}1 & if k = {u}_{m} , for m ∈ \{ 1 , 2 …M \} \\ 0 & otherwise \end{matrix} \\ Maximizes {min}_{i} ( {u}_{i + 1} - {u}_{i} )\end{matrix}$$

To optimize the carrier offset detection further conditions are considered.
Large u_{M}−u_{M-1}
Large u₂−u₁

For enhanced carrier offset detection the following conditions are considered.
u_{M}−u_{M-1}=u₂−u₁
Large u_{M}−u_{M-1}
Large u_{M-1}−u_{M-2}
   Large u₃−u₂

In a next step S4 a set of K binary vectors
Bₖ=(b₁^{k}, b₂^{k}, . . . , b_{M}^{k})
each composed of M binary preamble data samples bₘ^{k}ε{1, −1} is selected which satisfy:

$$\vert {\sum }_{m = 1}^{M} {b}_{m}^{k} \cdot {b}_{m}^{q} \vert \leq A$$

for any pair 0≦k,q<K, k≠q, Where

$$A = {max}_{m \neq 0} \{ AutoCorr ( m ) \}$$

is defined above

For enhanced carrier offset detection—b₁^{k}b_{M-1}^{k}=b₂^{k}b_{M}^{k}.

In a step S5 the binary preamble data samples are defined to be stored in the second preamble data sequence memory 14 of the preamble detector 12.

In a step S6 each preamble data sequence is spectrally shaped to get a preamble data sequence to be stored in a preamble data memory of the preamble generator 5.

Given a preamble in the time domain, p, the frequency domain representation is computed:

$${P}_{k} ( f ) = {\sum }_{n = 0}^{N - 1} {c}_{n}^{k} exp ( - j2 π fn / N ) , f = 0 , 1 , … , N - 1 , k = 1 , … , K$$

$$j = \sqrt{- 1}$$

The amplitudes are changed to reflect the desired spectral shape, while maintaining the phases:
Qₖ(f)=D(f)*exp(j2π·phase(Pₖ(f)).

Where D(f) defines the desired spectral shape.

After return to the time domain the modified preamble

$${Transmitted\_c}_{n}^{k} = {\sum }_{f = 0}^{N - 1} {Q}_{k} ( f ) \cdot exp ( j2π fn / N ) , \\ n = 0 , 1 , … , N - 1 , k = 1 , … , K$$

In a further step S7 the peak to average ratio of the calculated preamble data sequence to be stored in the preamble generator 5 is calculated and compared with the predetermined peak to average ratio PAR_{DATA} of the data section signal. If the peak to average ratio PAN_{P} of the preamble data sequence signal is higher than the peak to average ratio PAR_{DATA} of the data section signal the number (M) of non zero preamble data samples is incremented in a step S8 and the procedure returns to step S3. In the contrary case when the peak to average ratio PAR_{P} of the calculated preamble data sequence is smaller or equal to the peak to average ratio PAR_{DATA} of the data section signal the calculation of the preamble data sequence is completed.

The preamble data sequence can be defined as following:
A discrete time scale is assumed, where N is an integer number which represents the preamble length (number of discrete samples).
U=(u₁, u₂, . . . , u_{M}) is a vector composed of M monotonically increasing integers 0=u₁<u₂<u₃< . . . <u_{M}=N−1, 0<M<N.
U is also named a ‘locations-vector’. (u₁=0 and u_{M}=N−1)
B=(b₁, b₂, . . . , b_{M}) is a vector composed of M binary components bᵢε{1, −1}.

A pair (U, B) defines a preamble p(U, B) of length N, using the following definition:

$$p ( U , B ) = ( {c}_{0} , {c}_{1} , … , {c}_{N - 1} )$$

$${c}_{k} = \{ \begin{matrix}{b}_{m} & if k = {u}_{m} , for some m ∈ \{ 1 , 2 , … , M \} \\ 0 & otherwise\end{matrix}$$

The preamble is composed of N ternary preamble data samples, out of which M samples are non-zero (0<M<N). The locations of the non-zero elements are defined by the location vector U and the binary contents of the non-zero elements are defined by vector B.

The autocorrelation of the preamble p, is characterized by the autocorrelation:

$$AutoCorr ( m ) = {\sum }_{k = max ( m , 0 )}^{min ( N - 1 , N - 1 + m )} {c}_{k} \cdot {c}_{k + m}$$

The autocorrelation has a peak value at m=0, which is referred as the main lobe:
|AutoCorr(m)|≦AutoCorr(0)

The maximal time-domain side lobe of the preamble is defined by:

$$A ( p ) = {max \vert AutoCorr ( m ) \vert}_{m \neq 0}$$

It is desired to have small values of ‘A’.

A semi-orthogonal preambles-set is a set of K preambles {pₖ=p(U, Bₖ)} 0≦k<K, generated by a common locations-vector U (the locations of the non-zero components within each preamble are identical), and differs only in the binary vectors Bₖ=(b₁^{k}, b₂^{k}, . . . , b_{M}^{k}), where {Bₖ} is a set of ‘almost’ orthogonal vectors in the sense:

$$\vert {\sum }_{m = 1}^{M} {b}_{m}^{k} \cdot {b}_{m}^{q} \vert \leq A for any pair 0 \leq k , q < K , k \neq q$$

And where A is the maximal time-domain side lobe of the preamble p(U, B), and B=(1, 1, . . . , 1).

For any two preambles indices k≠q, the absolute cross correlation of the preambles pₖ and p_{q}, at any time m, is upper bounded by A:

$$\vert CrossCorr ( k , q , m ) \vert = \vert {\sum }_{n = max ( m , 0 )}^{min ( N - 1 , N - 1 + m )} {c}_{n}^{q} \cdot {c}_{n + m}^{k} \vert \leq A$$

In the following a calculation of a preferred preamble data sequence is presented.

The following example suits the current multi-band OFDM proposal for the IEEE 802.15.3a.

The preamble signal length is N=128 (sampled at 528 MHz). (Note that the multi-band OFDM uses a sequence of such preamble signals, hopping from band to band).

Locations vector U=(0, 9, 22, 33, 45, 53, 60, 70, 80, 88, 99, 106, 118, 127).

The number of non-zero samples in a preamble is M=14.

The preamble peak is 1, and the RMS is \sqrt{M/N}=\sqrt{14/128}, and therefore the PAR (in dB) is 10*log₁₀(128/14)=9.6 dB, which is close to the PAR_{D} that is required within the data sections of the multi-band OFDM for achieving the desired performance defined at IEEE 802.15.3a.

The maximal time-domain side lobe is A=2, which is 16.9 dB below the peak autocorrelation (AutoCorr(0)=M=14). This A=2 value is also the maximal absolute cross correlation between any two preambles which belong to a semi-orthogonal preambles set that is based on U.

Here is an example for the set of binary vectors:
B₀=(1, 1, 1, 1, 1, 1, 1, −1, −1, −1, −1, −1, −1, −1)
B₁=(1, 1, 1, 1, −1, −1, −1, −1, −1, −1, 1, 1, −1, 1)
B₂=(1, −1, −1, 1, 1, 1, −1, −1, 1, 1, −1, −1, −1, 1)
B₃=(1, −1, 1, −1, 1, −1, 1, −1, 1, −1, 1, −1, 1, −1)

The absolute auto-correlation side lobes and the absolute cross correlations, are significantly smaller then the achievable respective values by a binary-based preamble (prior art). Specifically the current proposed preambles for the IEEE 802.15.3a.

Around the peak of the autocorrelation (AutoCorr(0)), the auto-correlation is zeroed:

$$AutoCorr ( m ) = 0 for 0 < \vert m \vert < {min}_{i} ( {u}_{i + 1} - {u}_{i} ) .$$

This feature is referred as a narrow ‘main lobe’ of the time domain autocorrelation.

For example, for the numerical example above,

$${min}_{i} ( {u}_{i + 1} - {u}_{i} ) = 7.$$

This reduces the required length of the low pass filter 18 which is used to sum up incoherently the squared correlation output in the preamble detector. This reduction both reduces the receiver complexity, and improves its performance.

Additionally, this narrow-main lobe feature improves the performance of the timing detector.

As can be seen from step S6 in FIG. 9 the calculated preamble data sequence is spectrally shaped.

In many communication systems, there is a spectral limitation on the transmitted signal. It is therefore desired to modify the preamble power spectrum. For example, the spectral limitation for UWB signals is flat, while the spectrum of the preamble presented above is not flat. Additionally, it may be that the band edges of the data sections of the communications are shaped (e.g. for the purpose of simplifying signal processing at the device front end, or for reducing interference with adjacent spectral channels).

It is possible to modify the preamble spectrum by applying the following set of operations:
Given a preamble in the time domain, p, compute the frequency domain representation P=DFFT(p)
Change the amplitudes to reflect the desired spectral shape, while maintaining the phases of P. This means Q(f)=D(f)*exp(i*phase(P(f))), where D(f) is the desired spectral shape at frequency f and i=\sqrt{−1}.
Return to the time domain, deriving the modified preamble p_new=DFT⁻¹(Q)

By this spectral shaping, the transmitted preamble is no longer a sequence of ternary values. However, the receiver may still deploy the original ternary correlator, (which is no longer a matched filter). The performance degradation is small, and the receiver complexity remains small.

After spectral shaping the shaped preamble data sequence is stored in the preamble data sequence memory of the preamble detector 5 of the transceiver 1 according to the present invention.

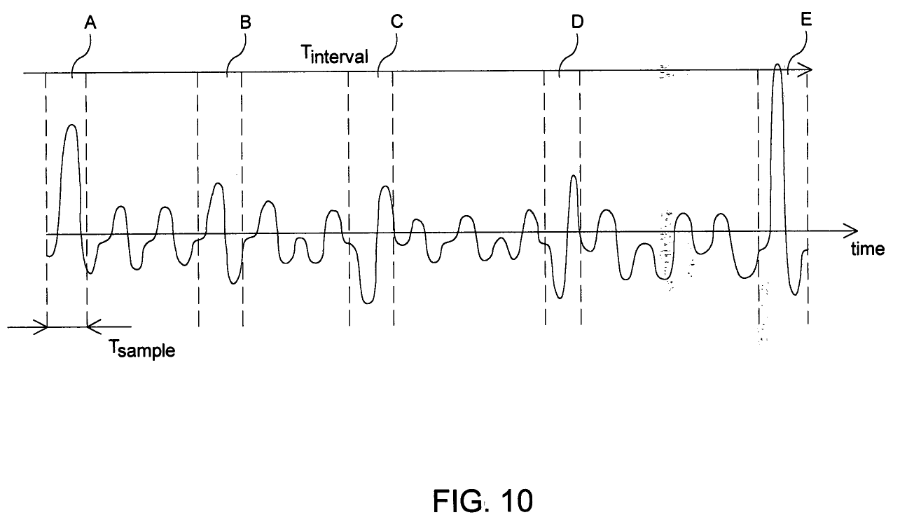

FIG. 10 shows an exemplary section of a preamble data sequence signal transmitted by the transceiver 1. For a bandwidth BW of e.g. 500 MHz the transmitting time for a preamble data sample Tₛₐₘₚₗₑ is 2 ns. The amplitude peak as shown in FIG. 10 corresponds to non zero preamble data samples of the preamble data sequence. The signal sections shown in FIG. 10 as non zero preamble data samples are sections A, B, C, D, E. The signal sections between the peaks correspond to preamble data samples having a value of zero. Corresponding signal sections are not zero because of the spectral shaping. The occurrence of peaks in the preamble data sequence signal is rare so that the preamble data sequence can be defined as a sparse preamble data sequence. In a preferred embodiment a preamble data sequence having 128 preamble data samples includes only 14 non zero preamble data samples. The density of non zero preamble data samples is low so that the cross-correlation properties of the preamble data sequences according to the present invention are improved.

The preamble data sequence according to the present invention is a sparse preamble data sequence. In a preferred embodiment the preamble data sequences stored in the memory of the preamble detector 12 are ternary preamble data sequences. The ternary preamble data sequences according to the present invention are in a preferred embodiment semi-orthogonal.

Using a sparse preamble sequences in the preamble generator 5 enables the detection by a simple ternary preamble sequence stored in the memory of the preamble detector 12.

The preamble data sequence signal as shown in FIG. 10 comprises high power signal sections A, B, C, D, F and low power signal sections in between. In a preferred embodiment high power signal sections in any time interval Tₛₐₘₚₗₑ (Tₛₐₘₚₗₑ≈1/BW) have an energy that is higher than the first threshold energy E1. In the low power signal sections every time interval of the duration Tₛₐₘₚₗₑ has an energy which is lower than a second threshold energy E2. In a preferred embodiment the burst upper energy threshold E1 is higher than twice the lower energy threshold E2.

In a preferred embodiment the duration of each high power signal section is more than a duration 4/BW.

In a preferred embodiment the length of each low power signal section is lower bounded by three times the length of the longest high power signal section. As can be seen in FIG. 10 the length of the low power signal sections are not constant. The high power signal sections are not equidistant to improve the cross-correlation of the preamble detector 12.

As can be seen from FIG. 8a the preamble detector 12 comprises a parameter extraction unit 22. One of the parameters extracted by the extraction unit 22 is the carrier offset i.e. the difference between the modulation carrier frequency and the demodulation carrier frequency. The carrier offset that is due to the fact that the transmitting transceiver and the receiving transceiver use different clock generators. The carrier offset detection is required at the receiving transceiver for enabling reliable information decoding.

In the standard IEEE 802.15.3a it is suggested to use time frequency interleaving (OFDM). Accordingly two consecutive OFDM data symbols which are transmitted by the same receiver utilize different spectral frequency bands. Therefore the frequency synthesizer generating the modulation carrier frequency hops between a set of various frequencies. Consequently any OFDM symbols which are transmitted by the same transceiver within a given specific frequency band are not phase-coherent.

The preamble data sequence for such a transceiver hops from frequency band to frequency band similarly to the OFDM band hopping. It means that a single preamble signal is transmitted in each frequency band. The lack of phase coherency between two preamble signals means that the carrier offset detector is in a preferred embodiment based on a single preamble signal.

In a preferred embodiment the carrier offset detector within the parameter extraction unit 22 is based on a single preamble signal as defined above.

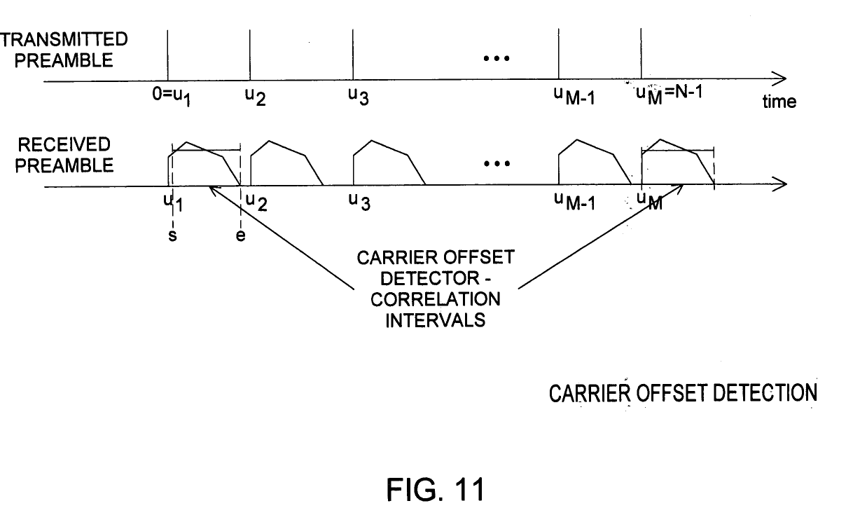

FIG. 11 illustrates the functionality of a carrier offset detector according to a first embodiment.

If u_{M}−u_{M-1} is larger than the significant time domain span of the channel impulse response, then the following carrier offset detection scheme is valid. (Assume that u₁=0 and u_{M}=N−1).
The preamble is detected
The timing of the peak correlation is identified. Let (r₀, . . . , r_{N-1}) be the received signal (the correlator input) with the highest absolute cross correlation with the preamble signal (c₀, . . . , c_{N-1}).
Let e be a positive number that satisfies 0<e<u₂.
Let s be a positive number that satisfies 0<s<e.

$$Z = angle ( {b}_{1} \cdot {b}_{M} {\sum }_{n = s}^{e} {r}_{n} \cdot {r}_{n + T}^{*} ) / ( 2 π {NT}_{S} )$$

is computed for deriving the carrier offset detector.

Note that e is preferably be selected based on the time domain main characteristics of the channel spreading.

FIG. 11 demonstrates this detection for B=(1, 1 . . . , 1).

The specific computation of Z may vary from implementation to implementation. It may, for example, include the channel response, the noise estimation and so on. However, the invention provides means for using a significant number of time-domain samples for the estimation by using a preamble sequence that has:
Large u_{M}−u_{M-1}
Large u₂−u₁

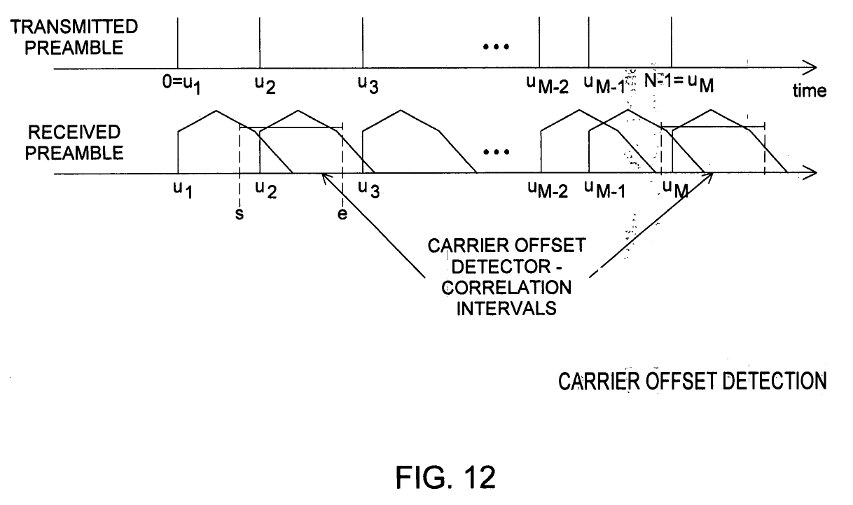

FIG. 12 illustrates the functionality of an alternative embodiment of the carrier offset detect on within the parameter extraction unit 22 of the preamble detector 12.

An alternative carrier offset detector can be implemented if u_{M}−u_{M-1}=u₂−u₁, and when b_{1*}b_{M-1}=b₂*b_{M} (which is the case for the numerical example above). In this case, the following detector replaces the last stages of the above scheme:
Let e be a positive number that satisfies 0<e<u₃.
Let s be a positive number that satisfies 0<s<e.

$$Z = angle ( {b}_{1} \cdot {b}_{M - 1} {\sum }_{n = s}^{e} {r}_{n} \cdot {r}_{n + {u}_{N - 1}}^{*} ) / ( 2 π {u}_{M - 1} {T}_{s} )$$

is computed.

Note that s and e are preferably be selected based on the channel spreading shape.

FIG. 12 demonstrates this detection for B=(1, 1 . . . , 1).

The specific computation of Z may vary from implementation to implementation. However, the invention provides means for using a significant number of time-domain samples for the estimation by using a preamble sequence that fulfills:
b_{1*}b_{M-1}=b_{2*}b_{M}
Large u_{M}−u_{M-1}=u₂−u₁
Large u_{M-1}−u_{M-2}
Large u₃−u₂

These properties are met by the numerical example (given above):
u_{M}−u_{M-1}=u₂−u₁=9
u_{M-1}−u_{M-2}=12
u₃−u₂=13

1. A preamble generator for a transceiver of a wireless local area network (WLAN), the transceiver of said wireless local area network (WLAN) configured to transmit data transmission burst signals, each including a preamble data sequence signal and a data section signal, the preamble data sequence signal associated with the data transmission channel of said wireless local area network (WLAN), the preamble generator comprising:
a first preamble data memory for storing a first set of preamble data sequences for a number of different data transmission channels,
wherein each preamble data sequence has a predetermined number (N) of preamble data samples including a number (M) of preamble data samples having large values, wherein (M) is such that the peak to average ratio (PARₚ) of the preamble data sequence signal corresponds to the peak to average ratio (PAR_{D}) of the data section signal.

2. The preamble generator for a transceiver according to claim 1 wherein the data samples having large values are distributed within the preamble data sequence unevenly.

3. The preamble generator for a transceiver according to claim 1 wherein the preamble generator comprises a first preamble selector for selecting a preamble data sequence from the first set of preamble data sequences stored in said first preamble data memory in response to a first selection control signal.

4. The preamble generator for a transceiver according to claim 1 wherein each preamble data sequence stored in said first preamble data memory is a time domain signal comprising a predetermined number (N) of preamble data samples.

5. The preamble generator for a transceiver according to claim 4 wherein each preamble data sample comprises a predetermined number (n) of preamble data bits.

6. The preamble generator for a transceiver according to claim 1 wherein the first set of preamble data sequences comprises a predetermined number (K) of preamble data sequences, the number (K) of preamble data sequences corresponding to a number of employable data transmission channels.

7. The preamble generator for a transceiver according to claim 5 wherein the number (n) of preamble data bits for each preamble data sample is at least two.

8. A preamble detector for a transceiver of a wireless local area network (WLAN), the transceiver of said WLAN configured to transmit data transmission burst signals, each including a preamble data sequence signal and a data section signal, the preamble data sequence associated with the data transmission channel of said WLAN, the preamble detector comprising:
(a) a preamble data memory for storing a set of preamble data sequences for a number of different data transmission channels,
wherein each preamble data sequence has a predetermined number (N) of preamble data samples,
wherein a number (M) of preamble data samples within the sparse preamble data sequence having a non zero value is such that the peak to average ratio (PAR_{P}) of the preamble data sequence signal corresponds to the peak to average ratio (PAR_{D}) of the data section signal, and
(b) a preamble selector for selecting a preamble data sequence from the set of preamble data sequences stored in said preamble data memory in response to a selection control signal.

9. The preamble detector for a transceiver according to claim 8 further comprising:
(c) a correlator unit which correlates a digitized time domain reception signal received by said transceiver with the selected sparse preamble data sequence to generate a correlation output signal.

10. The preamble detector for a transceiver according to claim 9 wherein the preamble detector includes an energy calculation unit which calculates an energy signal on the basis of the correlation output signal.

11. The preamble detector for a transceiver according to claim 10 wherein the preamble detector comprises a low pass filter for filtering the energy signal calculated by said energy calculating unit.

12. The preamble detector for a transceiver according to claim 11 wherein the preamble detector comprises a peak detector for detecting a peak of the filtered energy signal.

13. The preamble detector for a transceiver according to claim 9 wherein the transceiver transmits the transmission burst signals to a receiving transceiver of the same wireless local area network (WLAN) during data transmission intervals with changing frequency bands.

14. The preamble detector for a transceiver according to claim 13 wherein the preamble detector includes logic for evaluating the peak detection signals of the peak detector for all frequency bands employed during the transmission of the transmission burst signal.

15. The preamble detector for a transceiver according to claim 14 wherein the preamble detector includes a parameter extraction unit for extracting transmission parameters from the evaluated peak detection signals.

16. The preamble detector for a transceiver according to claim 15 wherein the parameter extraction unit extracts the carrier offset between the modulation carrier frequency of the transmitting transceiver and the demodulation carrier frequency of the receiving transceiver.

17. A transceiver for a wireless local area network (WLAN) which is operable simultaneously with other WLANs using different data transmission channels, the transceiver configured to transmit data transmission burst signals including a preamble data sequence signal and a data section signal, the preamble data sequence signal specific to the data transmission channel of the WLAN of said transceiver, wherein the transceiver comprises:
(a) a preamble data generator having:
(a1) a first preamble data memory for storing a first set of preamble data sequences for different data transmission channels,
wherein each preamble data sequence of the first set has a predetermined number (N) of preamble data samples,
wherein the number (M) of preamble data samples within the preamble data sequence having large values is such that the peak to average ratio (PAR_{P}) of the preamble data sequence signal corresponds to the peak to average ratio (PAR_{D}) of the data section signal,
(a2) a first preamble selector for selecting a preamble data sequence from the first set of preamble data sequences stored in said first preamble data memory in response to a first selection control signal;
(b) a preamble detector having:
(b1) a second preamble data memory for storing a second set of preamble data sequences for the different data transmission channels,
wherein each preamble data sequence of the second set has a predetermined number (N) of preamble data samples,
wherein the number (M) of preamble data samples within the preamble data sequence having a non zero value is such that the peak to average ratio (PAR_{P}) of the preamble sequence signal corresponds to the peak to average ratio (PAR_{D}) of the data section signal,
(b2) a second preamble selector for selecting a preamble data sequence from the second set of preamble data sequences stored in said second preamble data memory in response to a second selection control signal,
(b3) a correlation unit which correlates a digitized time domain reception signal received by said transceiver with the selected preamble data sequence to generate a correlation output signal;
(c) a control unit for generating the first selection control signal and the second selection control signal.

18. The transceiver for a wireless local area network (WLAN) according to claim 17 wherein the transceiver includes a scheduler which schedules a selected preamble data sequence output by said preamble generator before a digital time domain data section signal to form a digital transmission burst signal.

19. The transceiver according to claim 18 wherein the transceiver includes at least one digital to analog converter for converting the digital transmission burst signal to an analog transmission burst base band signal.

20. The transceiver according to claim 19 wherein the transceiver includes an up-converter which converts the analog transmission burst base band signal to an RF-transmission burst signal by modulating said analog transmission burst base band signal with a carrier signal having a modulation frequency within a predetermined transmission frequency band.

21. The transceiver according to claim 20 wherein the RF-transmission burst signal is transmitted during predetermined transmission intervals.

22. The transceiver according to claim 21 wherein the transmission frequency band is changed with every new transmission interval.

23. The transceiver according to claim 20 wherein the RF-transmission burst signal is a multi tone based modulated signal (OFDM).

24. The transceiver according to claim 21 wherein each transmission interval has a predetermined length (Tᵢₙₜₑᵣᵥₐₗ).

25. The transceiver according to claim 24 wherein the transmission interval length (Tᵢₙₜₑᵣᵥₐₗ) is a product of the number (N) of preamble data samples in a preamble data sequence and the duration (Tₛₐₘₚₗₑ) of a transmitted preamble data sample signal.

26. The transceiver according to claim 25 wherein the duration (Tₛₐₘₚₗₑ) of a transmitted preamble data sample signal is not higher than the inverse bandwidth (BW) of the frequency band employed for the transmission of the data transmission burst signal (Tₛₐₘₚₗₑ≦1/BW).

27. The transceiver according to claim 17 wherein the preamble data sequence signal comprises:
high power signal sections corresponding to the non zero data samples of the selected preamble data sequence; and
low power signal sections corresponding to the data samples of the selected preamble data sequence having a zero value.

28. The transceiver according to claim 27 wherein the high power signal sections have an energy which is higher than a first energy level (E1) and
the low power signal sections have an energy which is lower than a second energy level (E2),
wherein the first energy level (E1) is at least higher than twice the second energy level (E2).

29. The transceiver according to claim 27 wherein the duration (Tₛₐₘₚₗₑ) of a transmitted high power signal section is smaller than the inverse frequency bandwidth (1/BW) multiplied by a factor of four.

30. The transceiver according to claim 29 wherein the duration of a transmitted low power signal section is smaller by three times than the duration of a longest high power signal section.

31. The transceiver according to claim 17 wherein the preamble data samples stored in the second preamble data memory are ternary.

32. The transceiver according to claim 17 wherein each of the preamble data sample stored in the second preamble data memory have one of five complex values.

33. A method for calculating a preamble data sequence of a wireless local area network (WLAN)-transceiver comprising the following steps:
(a) calculating a number (M) of data samples having a non zero value depending on a predetermined number (N) of data samples of a preamble data sequence and a predetermined peak to average ratio (PAR_{D}) of an analogue data section signal wherein M=ceil[N/PAR_{D}];
(b) providing a set of binary vectors (B) wherein each binary vector (B) has (M) binary vector elements;
(c) determining a locations vector (U) composed of (M) monotonically increasing integer numbers which minimizes the absolute autocorrelation function |AutoCorr(m)|

$$\begin{matrix}and where Autokorr ( m ) = {\sum }_{K = max ( m , 0 )}^{min ( N - 1 , n - 1 + m )} {c}_{K} \cdot {c}_{K + m} \\ and {c}_{K} = \{ \begin{matrix}1 & if k = {u}_{m} , for m ∈ \{ 1 , 2 … M \} \\ 0 & otherwise\end{matrix} \}\end{matrix}$$
(d) selecting a set of K binary sectors (binary means±1) Bₖ=(b₁^{k}, b₂^{k} . . . b^{k}ₘ) which satisfy:
$$\begin{matrix}\vert {\sum }_{m = 1}^{M} {b}_{m}^{k} \cdot {b}_{m}^{q} \vert \leq A for any pair 0 \leq k < K , 0 \leq q < K , k \neq q \\ where A = {max}_{m \neq 0} \{ AutoCorr ( m ) \}\end{matrix}$$
where K corresponds to the number of data transmission channels of the transceiver.
(e) Using preamble K data sequences, defined by the K pairs (U, Bₖ), as:
$$\begin{matrix}P ( U , B ) = ( {c}_{0} , {c}_{1} … {c}_{N - 1} ) \\ {c}_{n} = \{ \begin{matrix}{b}_{m}^{k} & if n = {u}_{m} , for m ∈ \{ 1 , 2 … M \} \\ 0 & otherwise\end{matrix} \}\end{matrix}$$

34. Method according to claim 33 wherein the calculated preamble data sequence is spectrally shaped.

35. Method according to claim 34 wherein the peak to average ratio (PAR_{P}) of the analogue preamble signal for the spectrally shaped preamble data sequence is calculated.

36. Method according to claim 35 wherein the calculated peak to average ratio (PAR_{P}) is compared with the peak to average ratio (PAR_{D}) of the analogue data section signal.

37. Method according to claim 36 wherein the spectrally shaped preamble data sequence is stored as a preamble sequence in a preamble data memory of the transceiver when the peak to average ratio (PAR_{P}) of the analogue preamble signal is equal or smaller than the peak to average ratio (PAR_{D}) of the data signal section (PAR_{P}≦PAR_{D}).

38. Method according to claim 36 wherein the spectrally shaped preamble data sequence is stored as a preamble sequence in a preamble data memory of the transceiver when the peak to average ratio (PAR_{P}) of the analogue preamble signal is comparable with the peak to average ratio (PAR_{D}) of the data signal section (PAR_{P}≈PAR_{D}).

39. A transceiver for a wireless local area network (WLAN) which is operable simultaneously with other wireless local area networks (WLANs) using different data transmission channels,
wherein the transceiver transmits analogue data transmission burst signals including an analogue preamble data sequence signal which is specific for the data transmission channel of the wireless local area network (WLAN) of said transceiver and an analogue data section signal,
wherein the transceiver comprises:
(a) a preamble data generator having:
(a1) a first preamble data memory for storing a first set of preamble data sequence for the different data transmission channels,
wherein each preamble data sequence has a predetermined number (N) of preamble data samples,
(a2) a first preamble selector for selecting a preamble data sequence from the first set of preamble data sequences stored in said first preamble data memory in response to a first selection control signal;
(b) a preamble detector having:
(b1) a second preamble data memory for storing a second set of preamble data sequences for the different data transmission channels,
wherein each preamble data sequence has a predetermined number (N) of preamble data samples,
(b2) a second preamble selector for selecting a preamble data sequence from the second set of preamble data sequences stored in said second preamble data memory in response to a second selection control signal,
wherein corresponding preamble data sequences of the first and second set are matching preamble data sequences which generate when cross correlated with each other a value which is close to an auto correlation value of the preamble data sequence of the first set.
(b3) a correlation unit which correlates a digitized time domain reception signal received by said transceiver with the selected preamble data sequence to generate a correlation output signal;
(c) a control unit for generating the first selection control signal and the second selection control signal.
